(19) United States
(12) Patent Application Publication
(10) Pub. No.: US 2007/0033053 A1
(43) Pub. Date: Feb. 8, 2007

(54) User-adaptive dialog support for speech dialog systems

(75) Inventors: Susanne Kronenberg, Ulm (DE); Alexandros Philopoulos, Zurich (GR)

Correspondence Address: AKERMAN SENTERFITT, P.O. BOX 3188, WEST PALM BEACH, FL, 33402-3188, US

(73) Assignee: Daimler Chrysler AG, Stuttgart (DE)

(21) Appl. No.: 10/576,036

(22) PCT Filed: Jul. 20, 2004
(86) PCT No.: PCT/EP04/08085

§ 371 Date: Jul. 24, 2006

(30) Foreign Application Priority Data
Oct. 14, 2003 (DE) 103 48 408.6

(51) Int. Cl. G10L 21/00

(52) U.S. Cl. 704/275

(57) ABSTRACT

A common problem faced by speech dialog systems is that they have to serve users with varying degrees of experience of such a system in an optimal manner. The invention relates to a speech dialog system that differentiates between inexperienced and experienced users and generates speech prompts that are adapted accordingly. The system is able to differentiate between inexperienced and experienced users, issuing a detailed speech prompt to the former and an abbreviated speech prompt to the latter. According to the invention, the speech dialog system initialises a dialog step using an abbreviated speech prompt. If the system user does not react to the abbreviated speech prompt after a specified time (recognition timeout), a detailed speech prompt is issued. Thus both types of speech prompts are issued for each dialog step and are available to the system user for selection. The user can therefore always select the type and manner of dialog he or she requires. The experienced user therefore always has the option of taking the initiative with regard to the course of the dialog. If at one point in the speech dialog he or she is unsure of the type of speech response that is expected by the speech dialog system, he or she can simply wait for the recognition timeout and then receive a detailed speech prompt.

### CROSS REFERENCE TO RELATED APPLICATION

This application is a national stage of PCT/EP2004/008085 filed Jul. 20, 2004 and based upon DE 103 48 408.6 filed Oct. 14, 2003 under the International Convention.

### BACKGROUND OF THE INVENTION

1. Field of the Invention

The invention relates to a method for user-adaptive dialog support for speech dialog systems.

Speech dialog systems (speech recognition systems) are being increasingly used to operate complex technical devices, in particular assistance systems in motor vehicles, since in this context it is assumed that a purely spoken interaction distracts the operator of the technical device less from their primary operator control function than would be the case with haptic/visual operator control.

However, in speech dialog systems there is generally the problem that the system has to be operated in a way which is as far as possible optimum in terms of speech by users which have different degrees of experience, for example a beginner who is not familiar with the system or else an expert who knows and masters the system in all its details and fine points. Different demands can be made of the way in which the operator controls the speech dialog system depending on these different degrees of familiarity with the system. A beginner requires more help and guidance by the system in order to become familiar with it through learning-by-doing. However, an expert would like to interact with the speech dialog system as quickly and effectively as possible. Furthermore, modern speech dialog systems are becoming more and more complex since the variety of the functions to be operated is increasing. This implies that in future there will no longer be experts or beginners. There will be users who frequently use some of the offered functionalities and are experts in them, and there will be users who are in turn familiar only with a different part of the system.

There are speech dialog systems in which it is possible for the system user to specify how familiar he already is with the system. Accordingly, the dialog system interacts with the system user by means of relatively short or relatively long system utterances (prompts). However, the settings for the degree of familiarity are input actively by the system user and the respective settings thus relate to the entire dialog. This therefore does not cover cases in which a system user is, for example, extremely familiar with the speech dialog system but, for one dialog step, has forgotten which utterance is expected by the system in response to a prompt in order to move on appropriately in the dialog. In such a case it does not help the system user that he has the possibility of changing the system setting for his degree of familiarity and thus informing the system that he requires more support from the speech dialog system since in the subsequent dialog steps this support is again no longer required. In addition, it is problematic here that as a result of the necessary inputting of the degree of familiarity the system functionality depends greatly on the self-assessment of the system user.

2. Description of Related Art

It is therefore desirable for the speech dialog system to offer support automatically if the system user has difficulties with inputting the necessary speech utterances. Such a system is described in laid-open patent application US 2002/0147593 A1. In this document the speech dialog system is capable of outputting two prompts with different degrees of detail, in each case as a function of whether the system assumes that the system user is a beginner in need of support or an experienced expert. In communication with a beginner, the speech dialog system uses prompts with the degree of detailing which is customary for such systems, that is to say provides sufficient information about the type and manner of the user utterance which is appropriately expected within the scope of the dialog. If the system user is an expert only a shortened, optimized prompt (“tapered” prompt) is output. Generally, these shortened prompts do not contain any explanatory or supportive information, or only very little explanatory or supportive instructions. During the course of the dialog, the speech dialog system continuously assesses the system user with respect to his degree of experience and configures its prompts correspondingly. Since the system does not know anything about the system user when the speech dialog is initiated, speech prompts are firstly provided with the customary degree of detailing. In cases in which it is detected in the course of the dialog that the system user reacts appropriately to the prompts over a certain number of successive dialog steps it is assumed that the user is an expert, in response to which the prompts following this assessment are produced in the form of short prompts. However, since this assessment may be incorrect, the outputting of short prompts is continued only for as long as the system user reacts to them correctly and appropriately. If the system user reacts to the short prompts with utterances which the speech dialog system cannot appropriately further process, it changes over to generating prompts with the customary degree of detail again for the repeated enquiry and subsequently. The system does not return to using the short prompts until after the user has reacted appropriately again to the detailed prompts over a certain number of successive dialog steps. This switching back to the detailed prompts which are intended for the inexperienced system user is necessary since the speech dialog system can only infer the degree of experience of the system user on the basis of the manner of the utterance he makes in response to the prompt. It is problematic here that in cases in which an expert makes an incorrect input, for example due to a distraction, he subsequently receives repeated and unnecessarily detailed prompts which he could experience as disruptive.

### SUMMARY OF THE INVENTION

The object of the invention is therefore to find a user-adaptive dialogue guide for speech dialog systems which differentiates inexperienced and experienced system users, and generates prompts which are adapted thereto in such a way that even in cases in which an experienced user has reacted incorrectly within a dialog step, he is directly treated again as an experienced user in the subsequent steps without disadvantages for inexperienced users.

In the method for user-adaptive dialog guidance, a speech dialog system outputs a speech prompt, in response to which the speech dialog system waits for an utterance by the system user. A speech recognition system is activated here in order to understand the utterance by the user. The speech dialog system is capable of differentiating inexperienced and experienced users, in which case it outputs a detailed prompt to inexperienced users, while it uses a shortened prompt for experienced users. In this context, the speech dialog system inventively initializes a dialog step with a shortened prompt (initiation signal). If the system user does not make an utterance in response to the shortened prompt, a detailed prompt is output after a specific time (speech recognition system timeout). Therefore, both types of prompts, a shortened prompt and a detailed prompt are made available to the system user at each dialog step. In this context, the dialog step always begins with a shortened prompt so that it is always possible for the experienced system user (expert) to take the initiative, that is to say he always has the possibility of deciding about the type of dialog. The experienced user thus always has the possibility of taking the initiative with respect to the dialogue sequence. If, at a point in the speech dialog, even he is unsure about what type of speech utterance the speech dialog system expects here, he can simply wait for the speech recognition system timeout to occur and then receives a detailed prompt. During the subsequent steps, the experienced user can make utterances again straightaway after the shortened prompt and therefore speed up the dialog.

With respect to the configuration of the shortened prompt it is, for example, conceivable to limit it to the most necessary information or to individual key words which particularly convey the actual detailed information. Otherwise, the efficiency of the speech dialog sequence can be increased in a particularly advantageous way if the shortened prompt is provided simply by a neutral audio signal which does not contain any specific information, which is comparable, for example, with the prompt for the telephone answering machine in which the caller is requested to speak after the tone or the beep.

The efficiency of the method can also be increased further in particular with respect to inexperienced systems users by virtue of the fact that the frequency with which a system user only makes an utterance in response to the outputting of the detailed prompt is logged in a memory unit. If a user makes an utterance only then on repeated occasions, that is to say he never reacts or reacts rarely to the shortened prompt, this is an indication that he could be an inexperienced system user. In this case, the time period for the speech recognition timeout, which defines the period of time between the shortened prompt and the detailed prompt, can be advantageously shortened. An appropriate number of repetitions which are necessary to shorten the speech recognition timeout could be preset to the number 3, i.e. if the system user makes utterances three times in succession only to the detailed prompt, the speech recognition timeout is shortened, for example halved. As a result, it would also be possible for an inexperienced system user to bring the speech dialog to the objective more quickly. It is conceivable here to set the speech recognition timeout again to the original time period if the system user has already reacted to the shortened prompt in one of the dialog steps; hereto it is of course also possible to log these cases and to reset the speech recognition timeout back to the original value after a plurality of successive utterances in response to a shortened prompt.

In a particular way, the change in the speech recognition timeout (shortening or lengthening) could also be configured in such a way that it takes place successively in a plurality of steps. For example, the shortening or subsequent lengthening of the speech recognition timeout could take place less abruptly. If the change for each further time when the reaction is the same as the preceding time is, for example, 10% of the preceding duration of the speech recognition timeout, the system would adapt itself almost imperceptibly to the system user. This means that for each further time when the system user reacted appropriately only to the detailed prompt the speech recognition timeout would be shortened, and that the speech recognition timeout would be increased again to the original value in steps for each further time when said user had subsequently already replied appropriately to the shortened prompt. In this context it would be possible to start the modification of the speech recognition timeout already after the first utterance of the system user, which would further increase the efficiency of the system.

A further increase in the efficiency of the speech dialog system can be achieved by making said system barge-in-capable. Barge-in permits the system user to break off the prompts of a speech dialogue system by his own speech input. Such a speech input may be, for example, the premature inputting of the utterance which is expected by the system, or else other information which influences the speech dialog. This speech input interrupts the further outputting of the prompt. This provides the advantage of more efficient interaction with the system by speeding up the speech dialog by virtue of the fact that the system user can interrupt and stop prompts. This provides the possibility that in particular an experienced system user, who requires help for a dialog step, can break off the detailed speech output already at the time at which he has received the instructions which are necessary for the subsequent utterance.

In a particularly advantageous way, the invention provides a speech dialog system which can react dynamically and quickly to the current operating control behavior of a system user. If the system user is familiar with the dialog system, the method permits efficient interaction since an utterance can be made immediately after the shortened prompt (initiation signal). If, on the other hand, difficulties arise with respect to the utterance to be made, the speech dialog system reacts correspondingly by outputting a supportive prompt. In this context, the speech dialog is by means of the method according to the invention simultaneously configured in such a flexible way that if difficulties occur with one of the dialog steps this does not have any effects on the reaction capability during the subsequent steps. If a system user has, for example, difficulties with the utterance to be made only because he was distracted at the time, a supportive prompt is presented to him, to which he can respond. However, at the next dialog step, he has the possibility again of making an utterance immediately after the shortened prompt (initiation signal), and of thus selecting the shorter and more efficient way through the speech dialog.

1-6. (canceled)

7. A method for user-adaptive dialog guidance for a speech dialog system,
in which a speech prompt is output by the speech dialog system,
wherein in response to this the speech dialog system waits for an utterance by the system user, for which purpose a speech recognition system is activated in order to understand the utterance by the user,
wherein the system differentiates inexperienced and experienced users and outputs a detailed prompt to inexperienced users, while it uses a shortened prompt for experienced users,
characterized in that a dialog step with a shortened prompt is initialized on the part of the speech dialog system,
after which a detailed prompt is output if there is no utterance by the system user in response to the shortened prompt after a specific time.

8. The method as claimed in claim 7,
wherein the shortened prompt occurs in the form of a short audible signal.

9. The method as claimed in claim 7,
wherein if the system user repeatedly fails to make an utterance in response to the shortened prompt, the time period for the speech recognition timeout after which a detailed speech output occurs is shorted.

10. The method as claimed in claim 9,
wherein the time period for the speech recognition system timeout is shortened as the number of instances in which there is no utterance in response to the shortened prompt increases and occurs in a plurality of stages.

11. The method as claimed in claim 9,
wherein if the system user already responds to the shortened prompt, the time period for the speech recognition system timeout is prolonged.

12. The method as claimed in claim 7,
wherein the speech dialog system is configured in such a way that the system user can interrupt the outputting of the prompt by prematurely inputting a speech utterance.
